(19) United States
(12) Patent Application Publication
(10) Pub. No.: US 2010/0196087 A1
(43) Pub. Date: Aug. 5, 2010

(54) METAL-TO-PLASTIC CONNECTION

(76) Inventors: Christian LANGER, Berlin (DE); Sebastian Taeubert, Berlin (DE); Joerg Geipel, Berlin (DE)

Correspondence Address: Muncy, Geissler, Olds & Lowe, PLLC, 4000 Legato Road, Suite 310, FAIRFAX, VA, 22033, US

(21) Appl. No.: 12/694,847

(22) Filed: Jan. 27, 2010

Related U.S. Application Data
(60) Provisional application No. 61/226,191, filed on Jul. 16, 2009.

(30) Foreign Application Priority Data
Feb. 2, 2009 (EP) 09001385.5

(51) Int. Cl. F16B 5/00; B23P 11/00

(52) U.S. Cl. 403/288; 29/505

(57) ABSTRACT

A method for producing a connection between a metal surface and a plastic surface, in which a collar-shaped bead and a lateral surface with a shoulder-shaped ledge for the placement of the plastic surface are formed at least one edge at the metal surface, before the placement of the plastic surface a strip-like seal is introduced onto the ledge. The plastic surface is placed on the ledge of the lateral surface in such a way that a lateral surface of the plastic surface is lined up with the lateral surface of the metal surface in a butt-joint-like manner, and a form-fitting, elastically supported connection is created by forming between at least one part of the lateral surface of the metal surface and one part of the lateral surface of the plastic surface, so that a substantially seamless and substantially smooth transition between the metal surface and plastic surface is formed at the connection site on the top side of the metal surface and the plastic surface.

This nonprovisional application claims priority to European Patent Application No. 09001385.5, which was filed on Feb. 2, 2009, and to U.S. Provisional Application No. 61/226,191, which was filed on Jul. 16, 2009, and which are both herein incorporated by reference.

### BACKGROUND OF THE INVENTION

1. Field of the Invention

The invention relates to a method for producing a connection and to a metal-to-plastic bond.

2. Description of the Background Art

The creation of reliable connections between metals and plastics is an important element in technology, particularly in fields in which optical control of fabrication processes is necessary. In the field of food technology, connections of this type often have increased requirements in regard to physical and chemical properties. In particular, a bond of this type must meet high requirements with respect to reliability and tightness and comply with the corresponding standards. Further, connections of this type are also subject to highly varying temperatures in the range of from −40° C. to 120° C. and highly varying pressures in the range of several bars. To be able to meet the high requirements, in conventional metal-to-plastic connections, the connection sites between the metal surfaces and the plastic surfaces are protected by means of mechanical fastening means, such as screws and clamps, and/or chemical sealants generally in the form of adhesives. It is disadvantageous, however, that the adhesives introduced between the sealing surfaces at the adjacent lateral surfaces of the metal surfaces or plastic lateral surfaces contain in part undesirable ingredients, may release these, and often are not sufficiently resistant to aging. Further, the manufacturing of mechanical fastening means is costly and they bring about numerous hygienic disadvantages, particularly during cleaning.

It is desirable, furthermore, particularly on the surface at the interface between the two materials to form a transition as flush and seamless as possible to prevent deposition of substances. In general, for this purpose, after the joining of both materials, laborious mechanical finishing steps are necessary to assure the necessary surface quality.

### SUMMARY OF THE INVENTION

It is therefore an object of the invention to provide a method for producing a connection between a metal surface and a plastic surface and a metal-to-plastic bond, each of which reduce the disadvantages of the prior art.

According to an embodiment of the invention according, a method is provided for producing a connection between a metal surface and a plastic surface, the method in which a collar-shaped bead and a lateral surface with a shoulder-shaped ledge for the placement of the plastic surface can be formed at least one edge at the metal surface, and before the placement of the plastic surface a strip-like seal is introduced onto the ledge, and the plastic surface is placed on the ledge of the lateral surface in such a way that a lateral surface of the plastic surface is lined up with the lateral surface of the metal surface in a butt-joint-like manner, and a form-fitting, elastically supported connection is created by means of forming between at least one part of the lateral surface of the metal surface and one part of the lateral surface of the plastic surface, so that a substantially seamless and substantially smooth transition between the metal surface and the plastic surface is formed at the connection site on the top side of the metal surface and the top side of the plastic surface.

According to another embodiment of the invention, a metal-to-plastic bond is provided, having a metal surface with a top surface and a lateral surface, whereby the lateral surface forms a shoulder-shaped ledge and a reverse profile perpendicular to the top surface.

In this regard, the bond has a strip-like seal, lying on the ledge, and a plastic surface with a lateral surface, which abuts the lateral surface of the metal surface partially in a butt-joint-like manner and whose bottom side lies at least partially on the seal. Furthermore, the bond provides a connection site, which forms a substantially seamless and substantially smooth transition between the metal surface and plastic surface on the top side of the metal surface and the plastic surface.

An advantage of the method of the invention is that two different materials can be joined together without additional mechanical or chemical fastening means. Further, formation of joints and steps at least at their top surfaces is prevented. As a result, it is possible to form an adhesive-free bond, which is impermeable to atmospheric gases and/or liquids as far as possible. In particular, during use in the food sector, the largely seamless nature of the surface and the absence of adhesives prevent undesirable deposition of substances or release of adhesives, which would change for the worse the hygienic or aseptic properties of the bond. Further, due to the forming process in conjunction with matched profile guidance of both lateral surfaces, a smooth transition is achieved between the top side of the metal surface and the top side of the plastic surface without the hitherto necessary additional finishing steps, such as, for example, polishing or milling.

In an embodiment, a reverse profile can be formed by forming at the lateral surface of the metal surface to secure the plastic surface against the metal surface from perpendicular displacement. Further, it is advantageous that the seal between the metal surface and the plastic surface include an elastic material such as, for example, Viton, rubber, or composite plastics, to create an elastic form fit, which acts substantially perpendicular to the metal surface. It is advantageous hereby if the outer edge of the plastic surface is suitably chamfered to promote the formation of the undercut lateral surface of the metal surface. According to another embodiment, it is advantageous to provide the lateral surface of the plastic surface with a stepped ledge as well. In this regard, the profile of the ledge is suitably selected, so that during forming only the bottom side of the ledge of the plastic surface lies on the seal and the bottom side, preferably at least one part of the plastic surface, can act as a spring between the inner edges of the opening of the metal surface during the forming process.

In another embodiment, the plastic surface at its outer edge can be completely surrounded by the metal surface. A possibility for the control of manufacturing processes can be created by this design, particularly with use of optically transparent plastics, without damage to the sensors due to direct contact with chemically or mechanically aggressive materials. It is also possible, furthermore, by selecting suitable plastics to send electrical or magnetic fields through the plastic surface or to receive these fields. Fields of this type are generally screened by metals.

Tests by the applicant have shown that in the plastic-to-metal bond of the invention, the seal is preferably made as an elastic, circumferential strip. Furthermore, the elastic properties and the geometric design of the seal can be suitably selected depending on the requirements and on the forces acting during the forming.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic sectional drawing through a metal surface with a plastic surface lying thereupon in an unconnected state;

FIG. 2 shows a schematic sectional drawing in the connected state according to a first embodiment;

FIG. 3 shows a schematic sectional drawing in the connected state according to another embodiment; and

FIG. 4 shows a top view of a metal surface with an embedded plastic surface in the connected state.

### DETAILED DESCRIPTION

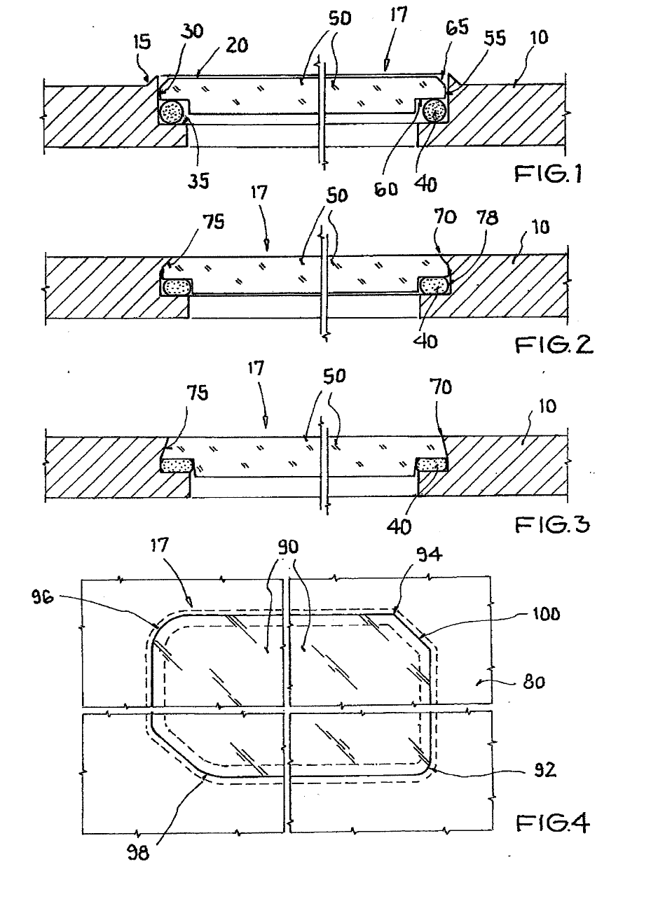

The sectional drawing of an unconnected arrangement as shown in FIG. 1 shows a metal surface 10 with a bead 15 formed at an edge 20 of metal surface 10. Further, metal surface 10 has a lateral surface 30 with a stepped ledge 35. A seal 40 lies upon ledge 35. Further, metal surface 10 has an opening 17 with an inner plastic surface 50. Plastic surface 50 has a lateral surface 55 with a stepped ledge 60. Further, a chamfer 65 is formed at the upper edge of plastic surface 50. According to the depicted embodiment, the extension of ledge 60 parallel to the top surface of plastic surface 50 is selected as somewhat greater than the extension of ledge 35. Further, the extension of ledge 35 in a direction perpendicular to the top surface corresponds to a sum of the thickness of plastic surface 50 and the thickness of seal 40. According to the depicted embodiment, the lateral surfaces 30, 55 of plastic surface 50 and of metal surface 10 are arranged in a butt-joint-like manner.

An embodiment according to the invention of metal surface 10 and of plastic surface 50 in a connected state, i.e., after use of the forming process, is shown in FIG. 2. In this regard, lateral surface 30 of the metal surface is connected largely form-fittingly with lateral surface 55 of plastic surface 50. Bead 15, as shown in FIG. 1, is no longer present on the top surface of metal surface 10, because the corresponding metal of metal surface 10 during formation, which can include pressing or another method known to one skilled in the art, of a reverse section 75 of side edge 30 forms a form fit with chamfer 65 of plastic surface 50. Furthermore, the top surface of plastic surface 50 forms a smooth and seamless transition with the top surface of metal surface 10 at connection site 70. Seal 40 is elastically deformed by the forming and now presses plastic surface 50 in a direction perpendicular to the top surface against the reverse section 75 of lateral surface 35 of metal surface 10. Further, by means of seal 40, lateral surface 35 of metal surface 10 is sealed against the lateral surface 55 of plastic surface 50 with the formation of a gap 78. Depending on the size and elasticity of the circumferential seal 40 and depending on the geometric dimensions of the material properties, to be joined, of the employed metal and plastic surfaces, as well as the geometry of the stepped ledges at the lateral edges, both the contact pressure of the plastic surface against the metal surface and the size of the gap at the lateral surface can be adjusted. Tests by the applicant have shown that despite a vertical gap between the seal and the lateral edge of the metal surface, reliable sealing in the area of the transition between the plastic surface and the metal surface is assured.

According to an embodiment shown in FIG. 3, a complete form fit between both surfaces is achieved in the area of the lateral surfaces of metal surface 10 and plastic surface 50. Accordingly, the space is completely filled by the seal between ledge 35 and ledge 60.

FIG. 4 shows a top view of a metal-to-plastic bond produced by the method of the invention, having a metal surface 80 and a plastic surface 90 with different edge shapes 92, 94, 96, and 98, which have different curvature radii. At a connection site 100, metal surface 80 and plastic surface 90 form a seamless and smooth transition. Despite the small curvature radius in the case of edge form 92, the appropriate ductility of the employed metal assures that a largely seamless and smooth transition is formed by means of the forming also in the edge regions on the top surface, without a mechanical finishing treatment of the top surface being necessary. Further, a reliable, mechanically strong, tight connection without the use of mechanical or chemical fastening means is provided, which is especially suitable for use in the field of food technology.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A method for producing a connection between a metal surface and a plastic surface, the method comprising:
forming a collar-shaped bead and a lateral surface with a shoulder-shaped ledge for the placement of the plastic surface are formed at least one edge of the metal surface;
introducing, before a placement of the plastic surface, a strip-like seal onto the ledge;
placing the plastic surface on the ledge of the lateral surface such that a lateral surface of the plastic surface is lined up with the lateral surface of the metal surface in a butt-joint-like manner;
forming a form-fitting elastically supported connection by forming between at least one part of the lateral surface of the metal surface and one part of the lateral surface of the plastic surface so that a substantially seamless and substantially smooth transition between the metal surface and the plastic surface is formed at the connection site on a top side of the metal surface and of the plastic surface.

2. The method according to claim 1, wherein a reverse profile is formed by forming the lateral surface of the metal surface.

3. The method according to claim 1, wherein the plastic surface at its outer edge is completely surrounded by the metal surface.

4. The method according to claim 1, wherein a stepped ledge is formed at the lateral surface of the plastic surface.

5. The method according to claim 1, wherein an elastic form fit, which presses the plastic surface substantially perpendicular to the top surface of metal surface, is created by the seal between the metal surface and the plastic surface.

6. The method according to claim 1, wherein an adhesive-free bond, which is impermeable to liquids, is formed between the metal surface and the plastic surface.

7. The method according to claim 1, wherein an adhesive-free bond, which is impermeable to atmospheric gases, is formed between the metal surface and the plastic surface.

8. A metal-to-plastic connection comprising:
a metal surface with a top surface and a lateral surface, the lateral surface having a shoulder-shaped ledge and a reverse profile perpendicular to the top surface of the metal surface;
a strip-like seal provided on the ledge;
a plastic surface with a lateral surface, which abuts the lateral surface of the metal surface partially in a butt-joint-like manner and the bottom side of the plastic surface lies partially on the seal;
a connection site, which has a substantially seamless and substantially smooth transition between the metal surface and plastic surface on the top side of the metal surface and of the plastic surface.

9. The metal-to-plastic connection according to claim 8, wherein the metal surface has an opening with a plastic surface arranged therein.

10. The metal-to-plastic connection according to claim 8, wherein the seal is formed as an elastic, circumferential strip.

11. The metal-to-plastic connection according to claim 8, wherein the connection site forms an adhesive-free transition between the lateral surface of the metal surface and the lateral surface of the plastic surface.
